(19) United States
(12) Patent Application Publication
(10) Pub. No.: US 2013/0017339 A1
(43) Pub. Date: Jan. 17, 2013

(54) ECO-FRIENDLY PROCESS FOR COATING A PLASTIC PRODUCT

(71) Applicant: Tiao-Tang LI, New Taipei City (TW)

(72) Inventor: Tiao-Tang LI, New Taipei City (TW)

(21) Appl. No.: 13/183,462

(22) Filed: Jul. 15, 2011

(51) Int. Cl. B05D 1/04

(52) U.S. Cl. 427/458

(57) ABSTRACT

An eco-friendly process for coating a plastic product includes several steps: (a) adding a conducting material to a thermoplastic material, (b) mixing the conducting material and the thermoplastic material homogeneously, and then molding into a product (c) spraying charged paint uniformly on the product (d) baking the painted product in ambient temperature atmosphere. Under this arrangement, plastic product made of different material could be produced without pre-treatment.

### BACKGROUND OF THE INVENTION

1. Field of the Invention

The present invention relates to a process for coating a plastic product, and more particularly to an eco-friendly process in which a coating process combines with a thermal-cycling and an infrared baking technology for coating plastic products under certain temperature condition about 120-160° C.

2. Description of Related Art

In the past, when a factory wants to improve a coating quality of the plastic products, a lot of processes for coating are necessary.

A conventional process for coating a plastic product is as following: first, cleaning the surface of the plastic product; second, coating the surface of the plastic product with chemical adhesive; third, coating the surface of the plastic product with the paint mixed with the solvent (e.g. formaldehyde, methyl benzene . . . etc.); fourth, re-coating to increase the coating thickness; fifth, coating the surface of the plastic product with protective paint for reinforcing the hardness of product surface. However, it may cause lots of environmental pollution (e.g. water pollution, air pollution, soil pollution . . . etc.) and waste lots of resources (e.g. water, electric power . . . etc.) during these processes.

The disadvantage of the conventional process for coating a plastic product is as following:

1. The wasted paint and solvent cannot be reused during these processes, and it may be harmful to human body or cause kinds of the environmental pollution.

2. The baking process costs a lot of time after coating for reinforcing the adhesion between paint and surface, and it will consume large energy resources.

3. It is difficult to separate the paint from the plastic surface during the recycling, and the product is hard to recycle.

Furthermore, a conventional process for coating a plastic product has to suffer a procedure for baking the plastic product to harden the product. The baking temperature is about 120-220° C. However, the plastic product may be deformed and the strength of the product may be reduced because the baking temperature is too high.

The present invention has arisen to mitigate and/or obviate the disadvantages of the conventional method.

### SUMMARY OF THE INVENTION

The main objective of the present invention is to provide an eco-friendly process for coating a plastic product.

To achieve the objective, an eco-friendly process for coating a plastic product in accordance with the present invention comprises the following steps: (a) selecting a thermoplastic material which might be PA mixing with fiberglass or PBT mixing with fiberglass, and then adding a conductive material into the thermoplastic material to make the melting point of the thermoplastic material above 140° C.; (b) mixing the conductive material and the thermoplastic material together and pour into a mold for forming a plastic product by injection molding or compression molding; (c) spraying a kind of charged paint on the plastic product by an electrostatic gun, wherein the temperature condition of paint should be below 160° C.; (d) taking the plastic product into an oven, wherein the plastic product is baked under one certain temperature condition about 120-160° C. for 10 to 15 minutes.

Furthermore, the conductive material might be carbon nanotubes, graphite, carbon fibers, or black dyes with carbon element . . . etc. The electrostatic gun makes the paint charged and the charged paint is firmly attached on the plastic product. The resistivity of the paint in the present invention is around 10-1000000000000 ohm. The plastic product is baked through one thermal-cycling procedure or one infrared baking procedure for reinforcing the surface hardness. The failed product is taken into the heat-treatment after the broken-treatment and is baked under 190-260° C. to separate the paint from the thermoplastic material so that the separated thermoplastic material is recycled. The dust-collecting equipment can collect the non-coated paint in the chamber during spraying and the non-coated paint is collected for reusing.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of an eco-friendly process for coating a plastic product in accordance with the present invention; and

FIG. 2 is a flow chart for showing the recycling process in accordance with the present invention.

### DETAILED DESCRIPTION OF THE INVENTION

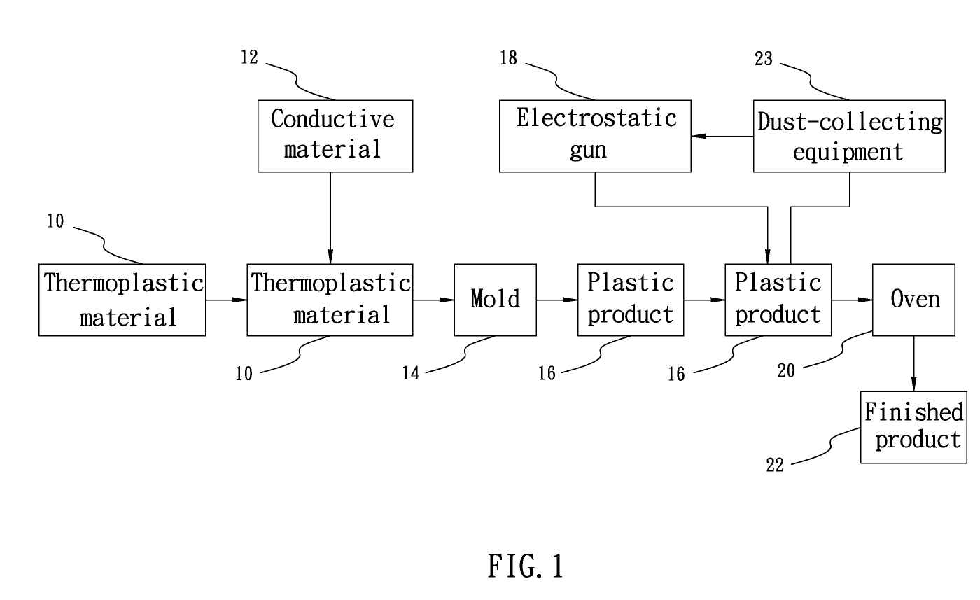

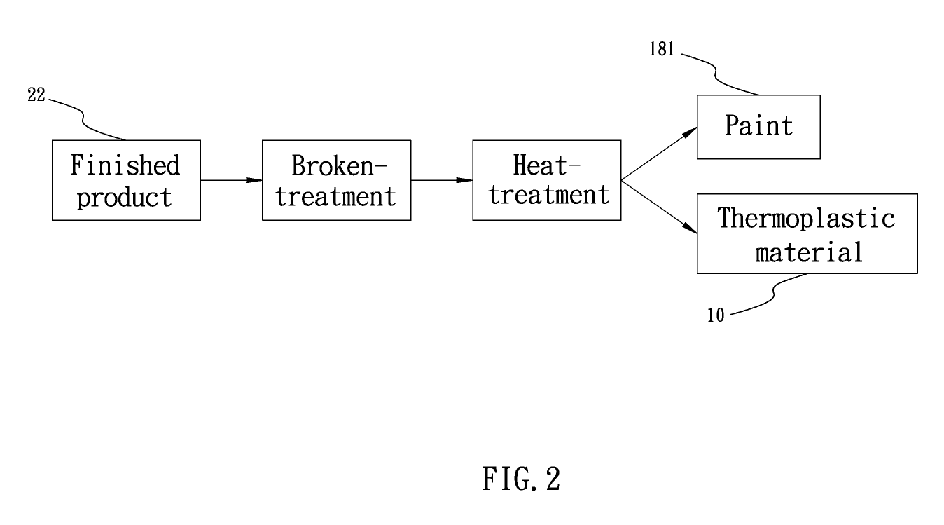

Referring to the drawings and initially to FIGS. 1-2, an eco-friendly process for coating a plastic product in accordance with the present invention comprises a thermoplastic material 10. The thermoplastic material 10 might be ABS, AS, PS, PP, PE, PA, PC, POM, PPE, PC mixing with ABS, PPO, TPU, PVC, PET, PBT, PBT mixing with fiberglass, PA mixing with fiberglass, ABS mixing with fiberglass, or PC mixing with fiberglass . . . etc. A conductive material 12 is added into the thermoplastic material 10. The conductive material 12 might be carbon nanotubes, graphite, carbon fibers, or black dyes with carbon element . . . etc. The conductive material 12 and the thermoplastic material 10 are mixing together and poured into a mold 14. Thereafter, a plastic product 16 is formed by injection molding or by compression molding. After the plastic product 16 is solidified, an electrostatic gun 18 sprays one kind of charged paint 181 (not shown) over the plastic product 16. The electrostatic gun 18 makes the paint 181 charged and the temperature condition of the paint 181 should be below 160° C. Finally, the plastic product 16 is taken into an oven 20 (tunnel type). The plastic product 16 is baked by a thermal-cycling procedure or an infrared baking procedure. The plastic product 16 is baked under a certain temperature condition about 120-160° C. for 10 to 15 minutes (the parameters of temperature and duration are based on the patterns of the plastic product 16). After these processes mentioned above, a finished product 22 comes to the world.

One advantage of the present invention should be mentioned here. A conventional thickness of paint on the product is only 30 μm. However, the thickness of paint 181 on the plastic product 16 according to the present invention can reach 60-120 μm. Therefore, the paint 181 is firmly attached on the plastic product 16 and makes the finished product 22 more graceful and attractive.

The eco-friendly process for coating a plastic product comprises the following steps:
(a) select one thermoplastic material 10 which might be PA mixing with fiberglass or PBT mixing with fiberglass, and then add one conductive material 12 into the thermoplastic material 10 to make the melting point of the thermoplastic material 10 above 140° C.
(b) mix the conductive material 12 and the thermoplastic material 10 together and pour into one mold 14 for forming one plastic product 16 by injection molding or compression molding.
(c) spray paint 181 on the plastic product 16 by one electrostatic gun 18, wherein the electrostatic gun 18 makes the paint 181 charged and the temperature condition of the paint 181 should be below 160° C. Therefore, the paint 181 is charged through the electrostatic gun 18 and the charged paint 181 is firmly attached on the plastic product 16.
(d) take the plastic product 16 into one oven 20 (tunnel type) and bake the plastic product 16 through one thermal-cycling procedure or one infrared baking procedure for reinforcing the surface hardness, wherein the plastic product 16 is baked under one certain temperature condition about 120-160° C. for 10 to 15 minutes. After baking, one finished product 22 is produced.

In the present invention, the thermoplastic material 10 is PA mixing with fiberglass or PBT mixing with fiberglass because these two materials have the better performance. The electrostatic gun 18 directly sprays the paint 181 (the resistivity of the paint 181 in the present invention is around 10-1000000000000 ohm) over the plastic product 16 without any pre-treatments. Instead of any pre-treatment, the conductive material 12 is added into the thermoplastic material 10 for making the charged paint 181 sprayed over the plastic product 16 homogeneously. Thereafter, the plastic product 16 is taken into the oven 20 (tunnel type) and is baked through the thermal-cycling procedure and the infrared baking procedure. The melting point of the thermoplastic material 10 is above 140° C. Thus, the plastic product 16 is partially melting on its surface when the plastic product 16 is baking in the oven 20. Thereafter, the paint 181 is easily attached on the partial melting surface of the plastic product 16 so that the finished product 22 is produced efficiently. If the finished product 22 is failed to produce, the failed product can be recycled. The failed product is taken into the heat-treatment after the broken-treatment. The failed product is baked under 190-260° C. (based on the characteristic of the thermoplastic material 10). The paint 181 is easily separated from the thermoplastic material 10 during the heat-treatment because the pre-treatment is not necessary in the present invention. Consequently, the separated thermoplastic material 10 is recycled (as shown in FIG. 2).

Furthermore, the present invention comprises a dust-collecting equipment 23. When the paint 181 is spread during spraying, the dust-collecting equipment 23 can collect the non-coated paint 181 in the chamber and the non-coated paint 181 is collected for reusing. The recycled thermoplastic material 10 can be manufactured with various colors by the various colors of paint 181. However, the conventional recycling process only deal with the product without suffering any coating process, and the recycled material is manufactured for original color or black color.

1. An eco-friendly process for coating a plastic product comprising the following steps:
(a) selecting a thermoplastic material which could be PA mixed with fiberglass or PBT mixed with fiberglass where the melting point of said material is above 140° C., and then adding a conductive material into the thermoplastic material
(b) mixing the conductive material and the thermoplastic material together and pouring into a mold for forming a plastic product, a molding method could be injection molding or compression molding.
(c) spraying a charged paint on the plastic product by an electrostatic gun, wherein a temperature for painting is below 160° C.
(d) taking the plastic product into an oven, wherein the plastic product is baked under 120-160° C. for 10 to 15 minutes.

2. The eco-friendly process for coating a plastic product as claimed in claim 1, wherein the conductive material could be carbon nanotubes, graphite, carbon fibers, or black dyes with carbon element.

3. The eco-friendly process for coating a plastic product as claimed in claim 1, wherein the electrostatic gun makes the paint charged and the charged paint is attached on the plastic product.

4. The eco-friendly process for coating a plastic product as claimed in claim 1, wherein the resistivity of the paint in the present invention is at a range from 10 ohm to 10¹² ohm.

5. The eco-friendly process for coating a plastic product as claimed in claim 1, wherein the plastic product is baked through one thermal-cycling procedure or one infrared baking procedure to increase a surface hardness of the plastic product.

6. The eco-friendly process for coating a plastic product as claimed in claim 1, wherein a failed product is taken into the heat-treatment after a broken-treatment and is baked under 190-260° C. to separate the paint from the thermoplastic material so that the separated thermoplastic material is recycled.

7. The eco-friendly process for coating a plastic product as claimed in claim 1, wherein a dust-collecting equipment can collect a non-coated paint in a chamber during spraying and the non-coated paint is collected for reusing.
